(19) United States
(12) Patent Application Publication
(10) Pub. No.: US 2014/0042203 A1
(43) Pub. Date: Feb. 13, 2014

(54) FASTENING DEVICE

(71) Applicant: PLUS CORPORATION, Tokyo (JP)

(72) Inventor: Shinya ABE, Tokyo (JP)

(73) Assignee: PLUS CORPORATION, Tokyo (JP)

(21) Appl. No.: 13/961,202

(22) Filed: Aug. 7, 2013

(30) Foreign Application Priority Data
Aug. 10, 2012 (JP) 2012-178316

(51) Int. Cl. B25C 5/16

(52) U.S. Cl. CPC B25C 5/1603
USPC 227/120

(57) ABSTRACT

As a fastening device in which legs of a staple can be bent properly even when a large number of sheets of paper or sheets of hard paper are attempted to be fastened together, a fastening device is provided which includes a magazine portion accommodating staples and a housing portion including a staple driving blade between a handle portion and a base portion, wherein a pushing rod biased so that part of a distal end contacts a magazine front central inner surface is incorporated in a bottom central position of the magazine portion, and wherein the pushing rod defines a space for insertion of a staple between the magazine front central inner surface and an upper portion of the distal end and includes an inclined portion for contact of the pushing rod with the magazine front central inner surface at a lower portion of the distal end thereof.

### CROSS-REFERENCE TO RELATED APPLICATION

This application is based upon and claims the benefit of priority under 35 USC 119 to Japanese Patent No. 2012-178316 filed on Aug. 10, 2012, the entire contents of which are incorporated herein by reference.

### FIELD

The present invention relates to a fastening device for fastening together sheets of paper with a metallic staple or staples.

### BACKGROUND

In these days, fastening devices are used in many occasions which fasten together a plurality of sheets of paper with a metallic staple or staples which are driven out thereof.

These fastening devices are called staplers, and in these staplers, there are two types of staplers: in one type of staplers, legs of a staple are bent in a curved fashion when sheets of paper are fastened together therewith; and in the other type of staplers, legs of a staple are bent flat. In these days, the latter type of staplers are used in general, and these staplers are classified as a flat type because legs of a staple are bent flat.

Such staplers are used as one of office materials, and there occur situations from time to time in which legs of a staple cannot be bent properly when a large number of sheets of paper or sheets of hard paper are attempted to be fastened together, whereby the sheets of paper cannot be fastened together in an ensured and neat fashion.

Because of this, various means for transmitting smoothly the force of a staple driving blade to a staple have been devised, and for example, Japanese Unexamined Patent Publication No. 2004-050350 discloses one of such means. According to this patent literature, a structure is proposed in which a distal end of a staple driving blade has a shape in which both end portions are caused to project slightly downwards, so that a pressure that is to be applied to legs of a staple is transmitted properly to the staple.

However, as described above, machining the staple driving blade to form the projections at the distal end thereof involves machining the distal end of the staple driving blade to which a largest force is applied and hence where rigidity and durability are required to provide irregularities, and it has been difficult to machine a distal end of such a staple driving blade highly accurately.

### SUMMARY

An object of the invention is to provide a stapler which can increase probability with which a staple is bent properly by machining simply a distal end of a staple driving blade and adding parts in a relatively easy fashion.

According to an aspect of the invention, there is provided a fastening device having a magazine portion which accommodates a strip of staples between a handle portion and a base portion and a housing portion which includes a staple driving blade for driving out a staple, wherein the magazine portion incorporates a staple presser for pressing a staple against a front inner surface of the magazine portion and incorporates a pushing rod in a bottom central position of the magazine portion, wherein the pushing rod is biased so that a part of a distal end thereof is brought into contact with a magazine front central inner surface, and wherein the pushing rod defines a space where a staple of the strip of staples is inserted between the magazine front central inner surface and an upper portion of the distal end thereof and includes an inclined portion which brings the pushing rod into contact with the magazine front central inner surface at a lower portion of the distal end thereof.

In addition, in the fastening device described above, the pushing rod has a rod-shaped pushing rod main body portion, of which an axis is parallel to a longitudinal axis of the magazine portion, and the pushing rod has a pushing head portion which includes a lower projecting portion at a front end of the pushing rod main body portion, the lower projecting portion being as high as a vicinity of a lower surface of the magazine portion at a lower end thereof.

Further, in the fastening device described above, a groove is cut in the center of a lower end portion of the staple driving blade so as to extend upwards from the lower end portion so that the pushing head portion can be inserted thereinto.

The fastening device according to the invention has the pushing rod which defines the space where a staple of the strip of staples is inserted between the magazine front central inner surface and the upper portion of the distal end thereof, includes the inclined portion and is biased so as to bring the pushing rod into contact with the magazine front central inner surface at the lower portion of the distal end thereof. Therefore, when one of the strip of staples accommodated in the magazine portion is driven downwards by the staple driving blade, resistance to the downward pressure applied to the staple is imparted to near the center of a crown portion of the staple by the inclined portion after the crown portion of the staple has been inserted into the space defined so as to prevent the center of the crown portion from being buckled further downwards than shoulder portions of the staple to allow the staple to be driven properly into sheets of paper to be fastened together, whereby legs of the staple are bent properly to fasten the sheets of paper together in an ensured fashion.

In addition, the magazine portion incorporates the pushing rod which has the inclined portion and which is biased so that part of the distal end thereof is brought into contact with the magazine front central inner surface, and therefore, the fastening device can easily be produced.

Additionally, the pushing rod has the pushing head portion which includes the lower projecting portion at the front end of the pushing rod, and the lower projecting portion is as high as a vicinity of the lower surface of the magazine portion at the lower end thereof, whereby the resistance is imparted to the crown portion of the staple which is inserted into the space defined between the pushing head portion and the magazine front central inner surface until the staple is driven out of the magazine portion, so that the staple can be driven into the sheets of paper to be fastened together in a more ensured fashion.

Further, in the fastening device, the groove is cut upwards from the lower end portion of the staple driving blade so that the pushing head portion can be inserted thereinto, whereby the lower end portion of the staple driving blade can be brought into contact with the staple in both side positions of the groove so cut so that the staple is pressed downwards stronger at both sides of the crown portion thereof, thereby making it possible to drive out the staple in a more ensured fashion. In addition, after the staple is driven out, the pushing head portion is brought into contact with the magazine front central inner surface but is not brought into contact with the staple driving blade, thereby making it possible to allow not only the staple driving blade but also the housing portion and the handle portion to return to their original positions in a smooth fashion.

### BRIEF DESCRIPTION OF THE DRAWINGS

FIG. 1 is a front perspective view showing an external appearance of a fastening device according to the invention.

FIG. 2 is a front perspective view showing a state in which the magazine is pulled out of the fastening device according to the invention.

FIG. 3 is a sectional view of the fastening device according to the invention.

FIG. 4A and FIG. 4B show perspective views of main parts of a magazine main body portion of the fastening device according to the invention.

FIG. 5 is a bottom perspective view showing the main part of the magazine main body portion of the fastening device according to the invention.

FIG. 6A and FIG. 6B are sectional views showing a state in which a strip of staples is accommodated in the fastening device according to the invention.

FIG. 7A and FIG. 7B are sectional views showing an operating condition of the fastening device according to the invention that occurs when sheets of paper to be fastened together are held therein.

FIG. 8A and FIG. 8B are sectional views showing an operating condition of the fastening device according to the invention that occurs when a staple is driven to be inserted through the sheets of paper.

FIG. 9A and FIG. 9B are sectional views showing an operating condition of the fastening device according to the invention that occurs when the sheets of paper are fastened together.

### DETAILED DESCRIPTION

A fastening device called a stapler according to the invention takes the form of a flat type fastening device 100 which has a magazine portion 140 which accommodates a strip of staples and a housing portion 120 which includes a staple driving blade which drives out a staple from the magazine portion 140 between a handle portion 110 and a base portion 170 and includes a vertically movable clincher in the base portion 170 to bend legs of a staple flat.

In the following description, it is understood that the handle portion 110 is provided at an upper part, the base portion 170 is provided at a lower part, the handle portion 110 and the base portion 170 are connected together at a rear part, and the handle portion 110 and the base portion 170 are spaced apart from each other at a front part of the fastening device 100.

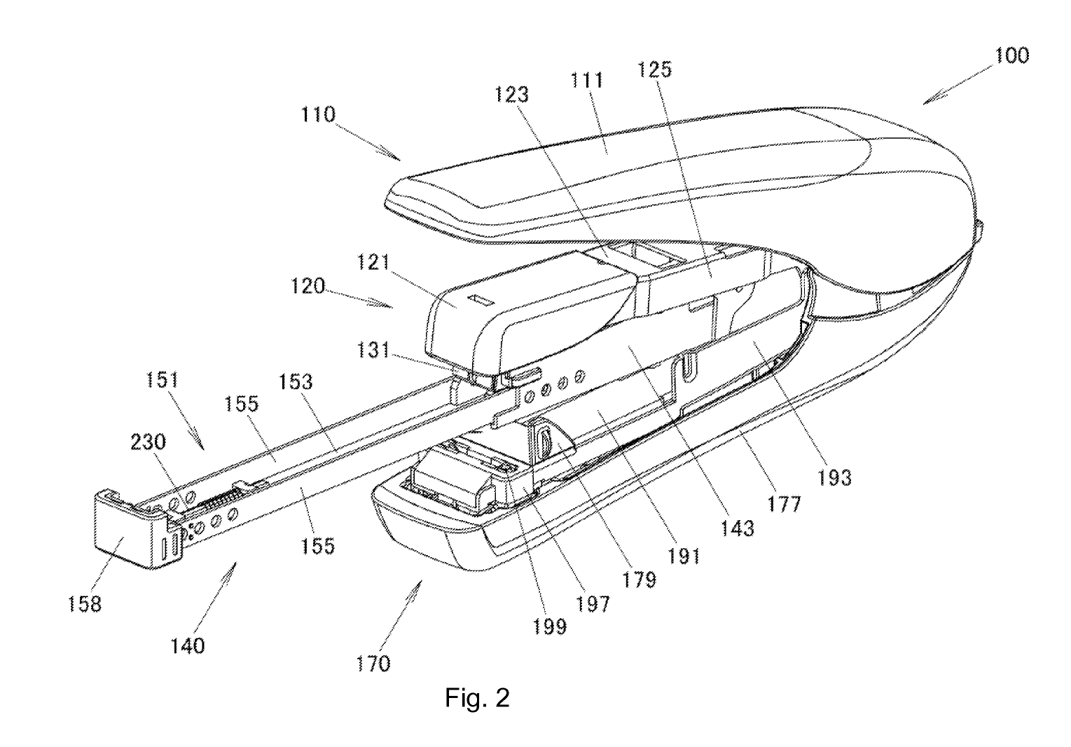

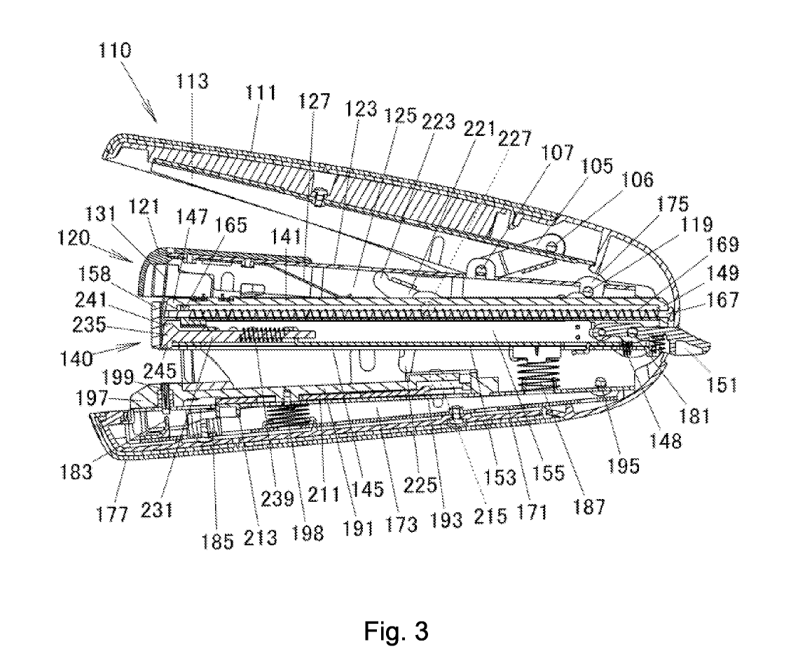

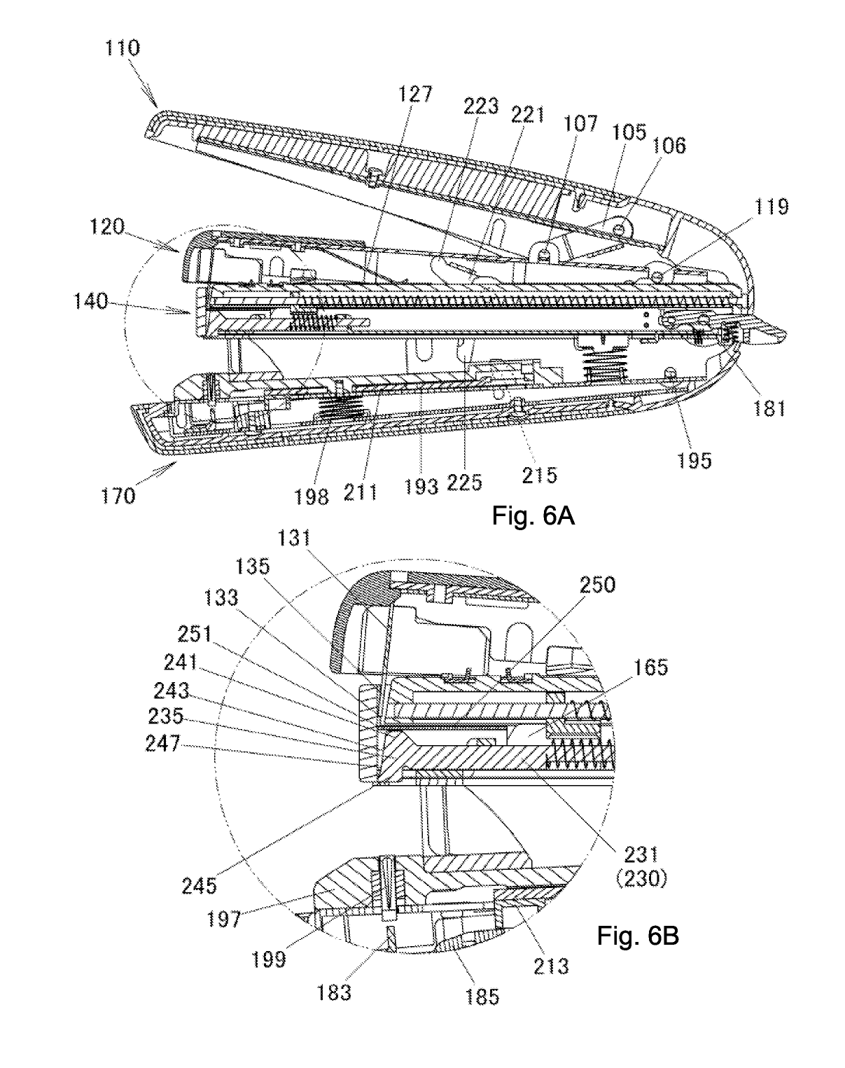

As shown in FIGS. 2 and 3 (as well as FIGS. 6A, 7A, 8A and 9A), in the fastening device 100, a handle arm 113 is provided in an interior of the handle portion 110, and this handle arm 113 has a required longitudinal length and is formed into a U-shape in cross section so as to be opened at a bottom side thereof to thereby ensure its rigidity. Additionally, in the handle portion 110, a handle cover 111 is placed on the handle arm 113, and a surface of this handle cover 111 is curved as required so as to facilitate the gripping of the fastening device 100.

In addition, the base portion 170, which is connected to the handle portion 110 at the rear, has a base plate including a base bottom plate 171 which has a plate shape and a required longitudinal length, base side plates 173 which rise along both sides of the base bottom plate 171 and high rising walls 175 which are caused to rise high near rear end portions of the base side plates 173. The base portion 170 also has a base cover 177 which covers the base bottom plate 171 and the base side plates 173 from below the base plate.

Further, the handle portion 110 is fixed rotatably to the base portion 170 via a handle shaft 119 which is provided near upper ends of the rising walls 175, and the housing portion 120 and the magazine portion 140 are mounted rotatably on the base portion 170 via a rotational shaft 181 which is provided in an intermediate height position near rear ends of the rising walls 175.

The housing portion 120 has in an interior thereof a housing top plate 123 which has a flat plate shape and a longitudinal length which is slightly shorter than the handle arm 113 and housing side plates 125 which extend downwards along either side of the housing top plate 123. The housing portion 120 also has a stale driving blade 131 inwards of and near a distal end thereof. The housing portion 120 includes a housing cover 121 which covers a distal end portion thereof.

The housing top plate 123 and the handle arm 113 are connected by a link bar 105. Specifically, a position on the housing top plate 123 which lies slightly rearwards of a center thereof and a position on the handle arm 113 which lies near a rear end thereof and further forwards than the handle shaft 119 are connected by the link bar 105. One end of the link bar 105 is rotatably fixed to the handle arm 113 via an upper link shaft 106 and the other end is rotatably fixed to the housing top plate 123 via a lower link shaft 107.

The housing portion 120 has the staple driving blade 131 for driving out a staple near the distal end thereof and incorporates an elastic element 127 which defines a predetermined space between a front end of the housing portion 120 and a front end of the magazine portion.

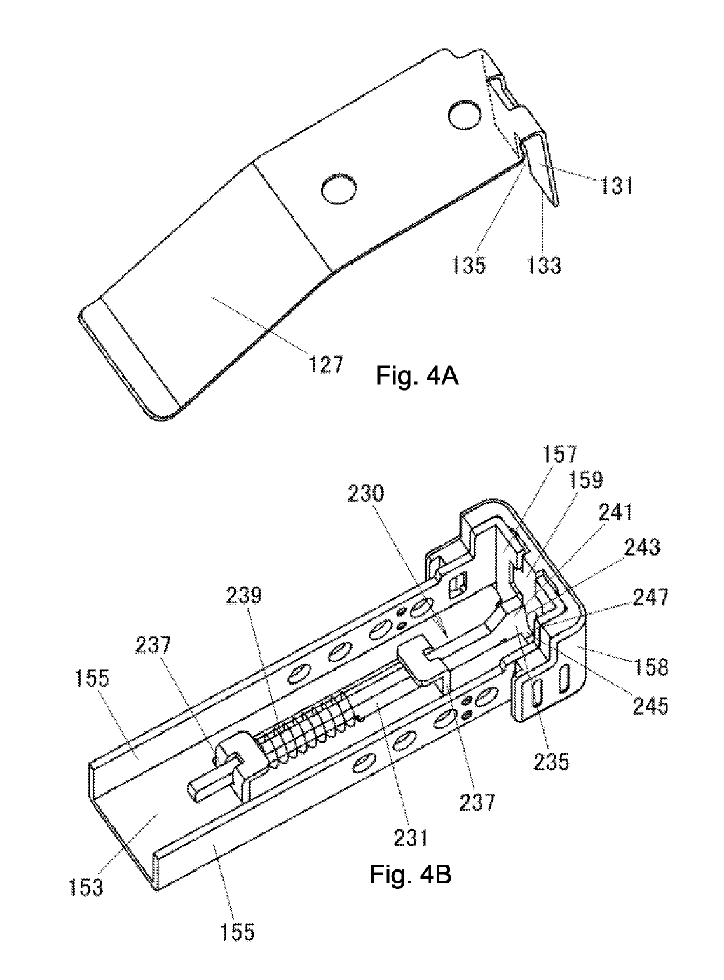

In this embodiment, as shown in FIGS. 3 and 4A, although the staple driving blade 131 and the elastic element 127 are formed into an integral steel plate, an elastic element 127 which is separate from the staple driving blade 131 can also be used as the elastic element 127.

In addition, in the magazine portion 140, as shown in FIG. 2, a magazine main body portion 151 can be pulled out of a magazine case.

This magazine case has a magazine case upper plate 141, magazine case side plates 143 which are suspended from the magazine case upper plate 141 along either side of the magazine case upper plate 141, and magazine case lower plates 145 which project inwards towards each other from respective lower ends of the left and right magazine case side plates 143, whereby the magazine case can hold the magazine main body portion 151 so as to slide back and forth in the longitudinal direction.

A magazine case front plate 147 is provided at a front end of the magazine case, and this magazine case front plate 147 extends slightly downwards from the magazine case upper plate 141. A space through which a staple is allowed to pass is defined below the magazine case front plate 147, and the magazine case front plate 147 prevents a staple presser 165 from projecting forwards from the magazine case. The magazine case front plate 147 also facilitates the insertion of a strip of staples into the magazine main body portion 151 when the magazine main body portion 151 is pulled out of the magazine case.

Further, as shown in FIGS. 3, 4A, and 4B, the magazine main body portion 151 has a magazine bottom plate 153 formed into a plate shape, magazine side plates 155 which rise from the magazine bottom plate 153 along either side of the magazine bottom plate 153, and magazine front plates 157 which extend inwards from either front ends of the magazine side plates 155. The magazine main body portion 151 is then accommodated within the magazine case. The magazine main portion 151 has a magazine head portion 158 which covers the magazine front plates 157 and the vicinities of the front ends of the magazine side plates 155.

A staple driving opening 161 through which a staple is driven out is defined between a front end of the magazine bottom plate 153 and the magazine front plates 157, and a magazine front central inner surface 159 of the magazine head portion 158 is formed at a central portion which is defined between the magazine front plates 157 which extend inwards towards each other from either of the magazine side plates 155, and the magazine front central inner surface 159 and inner surfaces of the magazine front plates 157 are substantially aligned with each other.

An elastic element 148 such as a coil spring and a stopper 152 are disposed at the rear of the magazine main body portion 151. The elastic element 148 biases the magazine main body portion 151 to the front, and the stopper 152 locks the magazine main body portion 151 in such a state that the magazine main body portion 151 is accommodated within the magazine case.

Further, the staple presser 165 is provided in an interior of the magazine main body portion 151, and the staple presser 165 presses the strip of staples accommodated in the interior of the magazine main body portion 151 to the front. The staple presser 165 has a U-shape and is opened at a bottom side thereof. The staple presser 165 can slide back and forth in the longitudinal direction while being in contact with the left and right magazine side plates 155. Thus, the staple presser 165 moves along a guide rod 167 which is bridged between the magazine case front plate 147 and guide support plate 149 which are provided at a rear end of the magazine case upper plate 141. An elastic element 169 such as a coil spring is disposed between the guide support plate 149 and the staple presser 165 so as to bias the staple presser 165 to the front.

This magazine main body portion 151 also includes a pushing rod 230 which includes a pushing head portion 235.

As shown in FIG. 4B, this pushing rod 230 has square rod-shaped pushing rod main body portion 231, and an axis of the pushing rod main body portion 231 is parallel to a longitudinal axis of the magazine main body portion 151. The pushing rod 230 is passed through support pieces 237 which are erected on the magazine base plate 153 and is accommodated at a transverse center of the magazine main body portion 151 in such a way as to be placed on the magazine bottom plate 153 so as to move back and forth in the longitudinal direction.

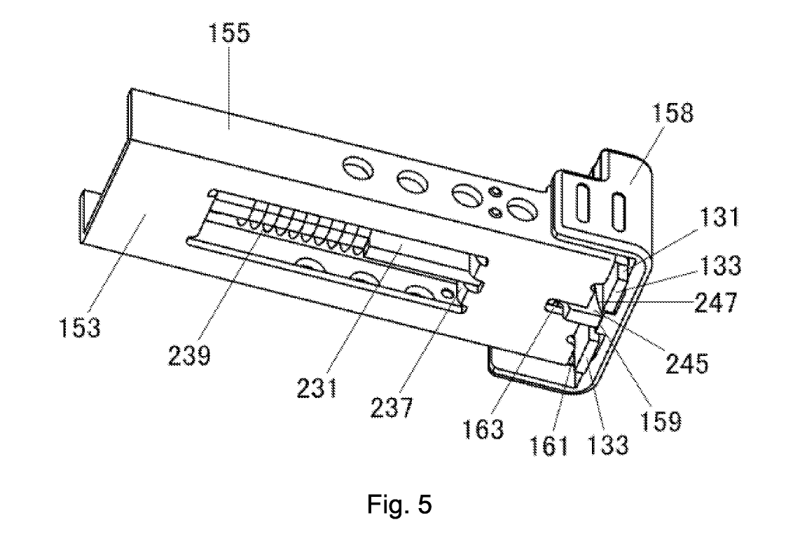

As shown in FIG. 5, the support pieces 237 are formed by cutting a portion out of the magazine bottom plate 153 with parts at an either side thereof left and bending upwards each of the parts, and a through hole having a square shape which matches the square shape of the pushing rod main body portion 231 is formed in each of the support pieces 237 so bent so that the pushing rod 230 can move back and forth in the longitudinal direction through the square through holes with the push rod main body portion 231 supported on an upper surface of the magazine bottom plate 153 in such a way as to prevent the rotation of the pushing rod 230 having the square rod shape.

An end portion of a pushing spring 239, which is an elastic element, is supported on one of the support pieces 237, so that the pushing rod 230 is biased to the front by the pushing spring 239.

Further, the pushing rod 230 has the pushing head portion 235 at a front end thereof, and the pushing head portion 235 has an upper projecting portion 241 which projects further upwards than the pushing rod main body portion 231 and a lower projecting portion 245 which projects further downwards than the pushing rod main body portion 231. The upper projecting portion 241 is slightly lower than a crown portion of a staple accommodated in he magazine main body portion 151, and although a lower end of the lower projecting portion 245 is caused to project slightly from the position of a lower surface of the magazine bottom plate 153, the lower end of the lower projecting portion 245 is positioned so as to be substantially same level with the magazine bottom plate 153. Thus, when the magazine main body portion 151 is accommodated in the magazine case, the lower end of the lower projecting portion 245 is positioned near a lower surface of the magazine portion 140 which is positioned slightly higher than a lower surface of the magazine case lower plate 145 or a lower surface of a lower end of the magazine head portion 158, that is, the lower surface of the magazine portion 140.

The staple driving opening 161 through which a staple is passed is provided between the front end of the magazine bottom plate 153 and the magazine front plates 157, and in the fastening device 100 of this embodiment, a cutout portion 163 is provided at a central position in a front end of the magazine bottom plate 153 so that the lower projecting portion 245 of the pushing rod 230 is accommodated therein so as to move freely back and forth in the longitudinal direction.

Additionally, a front end of the upper projecting portion 241 is formed into a front end surface 243 which is substantially perpendicular to the magazine bottom plate 153, and a front end of the lower projecting portion 245 is formed into an inclined portion 247 which is inclined slightly, whereby the pushing head portion 235 is formed into the shape which projects to the front at the lower portion thereof.

Because the pushing head portion 235 is given the shape described above, in such a state that the pushing rod 230 is biased to the front by the pushing spring 239 and the lower end of the inclined portion 247 is in abutment with the central inner surface 159 of the magazine head portion 158 which defines the surface which is substantially same level with the inner surfaces of the magazine front plates 157, the space is defined between the magazine front central inner surface 159 which is the inner surface of the magazine head portion 158 and a front end face 243 of the upper projecting portion 241, so that a crown portion 253 of one staple which is pressed against the inner surfaces of the magazine front plates 157 can be inserted into the space so as to be lowered thereinto.

In addition, as shown in FIG. 4A, the staple driving blade 131 has a groove 135 which is cut in a center of a lower end portion 133 thereof which is formed straight-line, and the groove 135 has a width which matches a width of the pushing head portion 235. When the lower end portion 133 of the staple driving blade 131 projects slightly downwards from the staple driving opening 161, as shown in FIG. 5, the inclined portion 247 of the pushing head portion 235 is accommodated in the groove 135 so cut.

In addition, the magazine portion 140 includes an elastic element 187 such as a coil spring between the magazine case lower plates 145 and a clincher base frame 193 so as to define a space between a front end of the magazine portion 140 and a front end of the base portion 170 so that sheets of paper to be fastened together can be held in the space defined.

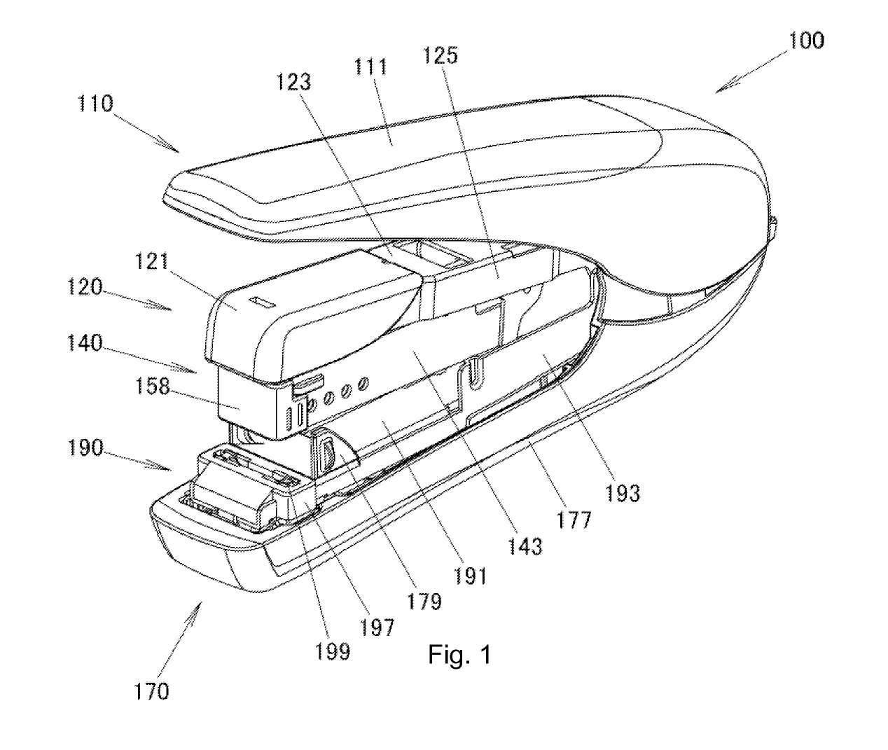

Further, the movable clincher 199 is provided in the base portion 170, and as shown in FIGS. 1 and 2, a paper spacer 179 is provided at the rear of a clincher cover 197 which accommodates the movable clincher 199. The paper spacer 179 can be adjusted in position in a longitudinal direction, so that an insertion amount of sheets of paper between the magazine portion 140 and the base portion 170 can be adjusted. Namely, a distance from an edge to a position on the sheets of paper where a staple is driven thereinto can be set in an adjustable fashion.

As a construction in which the movable clincher 199 is mounted in the base portion 170, there is adopted a construction in which the clincher base frame 193 is rotatably fixed to a lower portion of the rising walls 175 via a clincher pin 195 in a position which lies near a rear end thereof so that a front end of the clincher base frame 193 can be moved vertically. The clincher cover 197 which incorporates the movable clincher 199 is provided at a front end of a clincher base plate 191 which is provided on the clincher base frame 193, and an elastic element 198 such as a coil spring is disposed between the clincher base plate 191 and the base bottom plate 171 so as to push up the clincher base plate 191 and the clincher base frame 193 to bring a front end of the clincher base frame 193 into engagement with an inner side of a front end of the base cover 177, whereby the clincher cover 197 is positioned at a predetermined height.

In addition, a slider plate 211 is mounted on a lower surface of the clincher base plate 191 so as to slide back and forth in the longitudinal direction, and a slider projection 213 is provided at a front end of the slider plate 211 so as to project downwards. Upwardly projecting engagement projections 215 are provided individually on left- and right-hand sides of the slider plate 211 at a rear end thereof, and the slider plate 211 is biased to the front by an elastic element, not shown.

A slider receiver 185 is provided below the slider projection 213, and this slider receiver 185 is fixed to the base bottom plate 171. By causing a rear end of the slider receiver 185 to be superposed on a front end of the slider projection 213, the front end of the slider plate 211, that is, the front end of the clincher base plate 191 which includes the movable clincher 199 is prevented from being lowered.

A clincher locking portion 183 is provided on the base bottom plate 171 below the movable clincher 199, and when a front end of a clincher portion 190 is lowered, the clincher locking portion 183 is inserted into the clincher cover 197 to support the movable clincher 199 from therebelow. The elastic element 198 such as a coil spring is disposed between the base bottom plate 171 and the clincher base plate 191 so as to push up the clincher portion 190.

Further, two rotational arms 221 having the same shape are mounted rotatably on respective sides of both the magazine case side plates 143 by corresponding arm shafts 227, whose axes are aligned with each other, forwards of and above the engagement projections 215. Then, respective distal ends of first arms 223 which extend forwards and upwards from the arm shafts 227 are brought into contact with a lower surface of the housing top plate 123, and respective distal ends of second arms 225 which extend downwards from the arm shafts 227 are positioned forwards of and above the engagement projections 215.

These rotational arms 221 are mounted on the magazine case by the arm shafts 227, and therefore, when the magazine portion 140 is lowered, causing the staple driving opening 161 to approach the movable clincher 199, the distal ends of the second arms 225 are lowered to positions ahead of the engagement projections 215, and when the housing portion 120 approaches the magazine portion 140, causing a staple to be driven out from the staple driving opening 161 by the staple driving blade 131, the distal ends of the first arms 223 are pushed downwards by the housing top plate 123 to rotate, whereby the distal ends of the second arms 225 are moved to the rear, causing the engagement projections 215 and hence the slider plate 211 and the slider projection 213 to move to the rear.

In the fastening device 100 that is constructed as has been described heretofore, when the rear of the stopper 152 is pushed downwards, the magazine main body portion 151 is pushed slightly forwards by the elastic element 148, so that the magazine main body portion 151 can be pulled out of the magazine portion 140 as shown in FIG. 2 by gripping on the magazine head portion 158.

Then, a strip of connected staples 250 in which ordinarily, staples in the order of fifty are integrally connected is inserted into the magazine main body portion 151 so pulled out, and the magazine main body portion 151 is pushed back into the magazine case. Then, as shown in FIG. 6A and FIG. 6B, a rear end of the strip of connected staples 250 is pushed forwards by the staple presser 165, and a front end of the strip of connected staples 250 is pressed against the magazine front plates 157, whereby a leading staple 251 of the strip of connected staples 250 is positioned above the staple driving opening 161.

Then, sheets of paper which are superposed one on the top of the other are inserted from the distal end of the base portion 170 until they come to contact the paper spacer 179, whereafter the handle portion 110 and the base portion 170 are gripped together. Then, the distal end of the handle portion 110 rotates downwards about the handle shaft 119, and the housing portion 120 is rotated downwards by the link bar 105, whereby the magazine portion 140 rotates together with the housing portion 120 with a space defined between the magazine portion 140 and the housing portion 120 maintained by the elastic element 127, causing the distal end of the magazine portion 140 to be lowered.

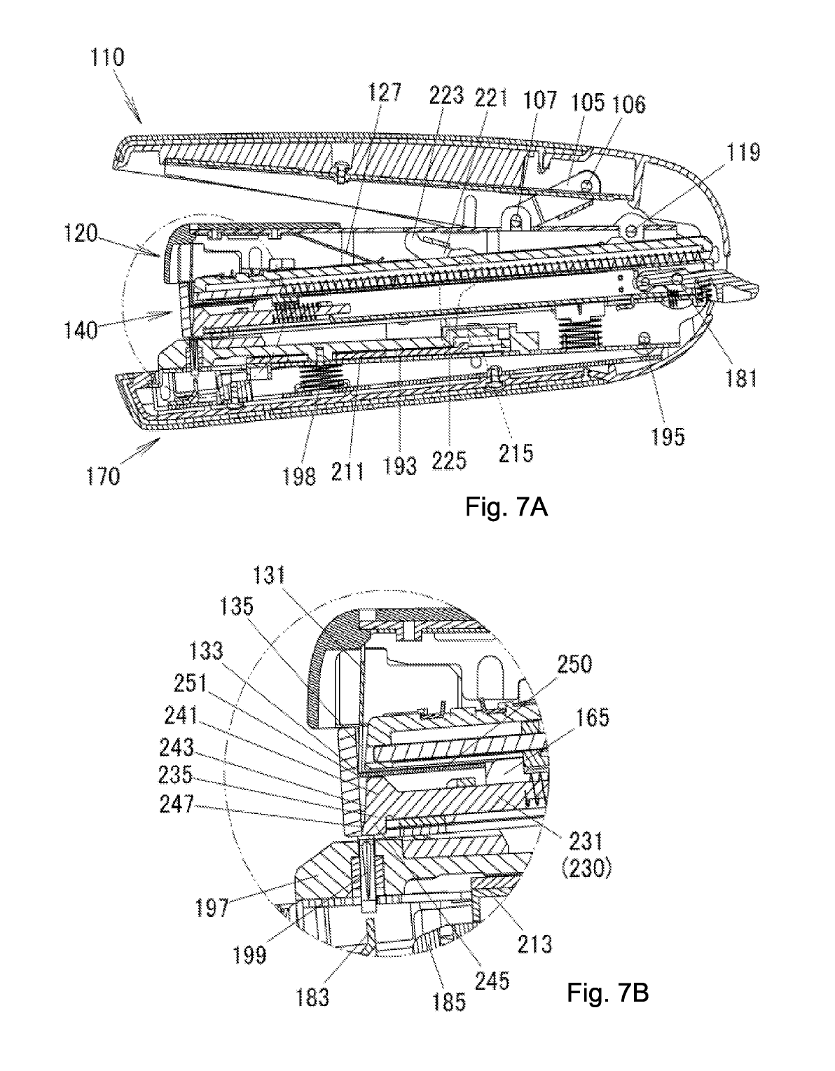

When the distal end of the handle portion 110 is lowered further, as shown in FIG. 7A and FIG. 7B, the distal end of the magazine portion 140 comes into contact with the superposed sheets of paper, not shown, so as to hold the superposed sheets of paper, not shown, by the distal end of the magazine portion 140 and the clincher cover 197 therebetween. Then, when the distal end of the handle portion 110 is lowered furthermore, the distal end of the housing portion 120 is lowered, causing the leading staple 251 of the strip of connected staples 250 to be driven downwards by the staple driving blade 131.

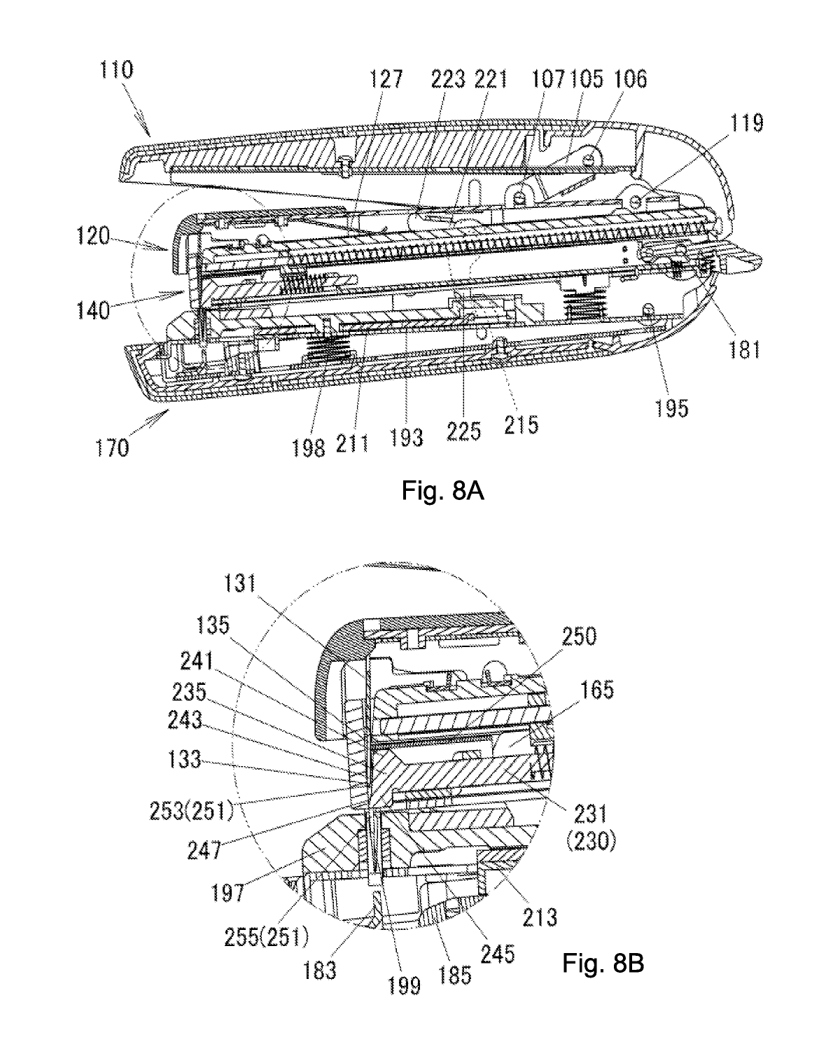

Then, a crown portion 253 of this leading staple 251 is lowered in the space defined between a front end face 243 of the upper projecting portion 241 of the pushing head portion 235 and the magazine front plates 157, and distal ends of staple legs 255 project from the staple driving opening 161 to be driven into the superposed sheets of paper, not shown, as shown in FIG. 8A and FIG. 8B. Then, the distal ends of the staple legs 255 are inserted into the movable clincher 199, and the crown portion 253 of the staple 251 is pushed downwards by the lower end portion 133 of the staple driving blade 131 having the groove 135 cut thereinto as the handle portion 110 is lowered.

Then, when the crown portion 253 is lowered to the inclined portion 247 of the pushing head portion 235, the staple 251 is driven out of the staple driving opening 161 in such way as to cause the pushing head portion 235 to retreat. Then, a central portion of the crown portion 253 bears resistance from the pushing head portion 235 as the staple 251 is lowered. Since this causes shoulder portions of the staple 251, which constitutes upper ends of the staple legs, and the vicinities of the shoulder portions to be pushed downwards strongly by the lower end portion 133 of the staple driving blade 131 and the central portion of the crown portion 253 bears the resistance from the pushing head portion 235, whereby the central portion of the crown portion 253 can be prevented from being buckled in such a way that the shoulder portions collapse inwards as a result of the central portion of the crown portion 253 being depressed lower than the shoulder portions of the staple 251 which are upper ends of the staple legs 255, thereby making it possible to make the leading staple 251 properly driven into the superposed sheets of paper.

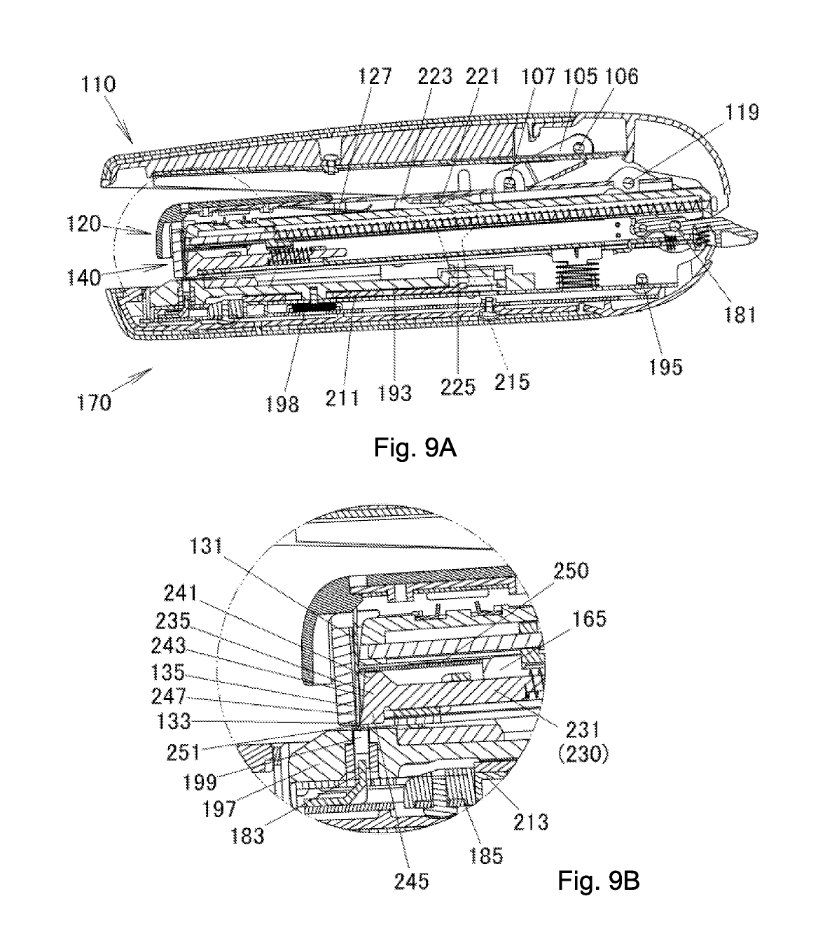

Further, when the staple 251 is substantially driven out of the staple driving opening 161 by the staple driving blade 131 while the staple legs 255 are being bent inwards as a result of the housing portion 120 being lowered, the engagement projections 215 are caused to move to the rear by the second arms 225 of the rotational arms 221, whereby the slider projection 213 is dislocated from the slider receiver 185, so that a front end of the clincher portion 190 can be lowered. This causes the clincher cover 197 to be lowered as shown in FIG. 9A and FIG. 9B, whereby the clincher locking portion 183 is brought into abutment with the movable clincher 199 from therebelow.

Consequently, the staple legs 255 of the staple 251 are held by the movable clincher 199 which is supported on a lower side thereof by the clincher locking portion 183 and the staple driving blade 131 so as to be bent properly, whereby the superposed sheets of paper can be fastened together.

In addition, the lower end of the lower projecting portion 245 which constitutes the lower end of the pushing head portion 235 is substantially same level with the magazine bottom plate 153 and as high as the position lying near the magazine portion lower surface which is slightly higher than the lower surface of the magazine portion 140. Therefore, the crown portion 253 of the staple 251 which is driven into the sheets of paper held between the lower surface of the magazine portion 140 and an upper surface of the clincher cover 197 is pushed further downwards than the lower end of the pushing head portion 235, and the crown portion 253 is positioned in a gap equal to the thickness of the staple which is defined between an upper surface of an uppermost sheet of paper and the lower end of the lower projecting portion 245, whereby the staple 251 is dislocated completely from the pushing head portion 235.

Consequently, the sheets of paper fastened together by the metallic staple 251 can be removed from the fastening device 100 easily and quickly.

Further, the distal end of the pushing head portion 235 which is dislocated from the crown portion 253 of the staple 251 is pushed to the front to advance by the pushing spring 239 to thereby be brought into abutment with the magazine front central inner surface 159. Then, when the force with which the handle portion 110 is gripped is released, the front ends of the handle portion 110 and the housing portion 120 are raised, whereby the staple driving blade 131 with the pushing head portion 235 accommodated in the groove 135 cut thereinto is allowed to be raided back to its original position.

In this way, the pushing rod 230 which brings the distal end of the pushing head portion 235 into abutment with the magazine front central inner surface 159 is accommodated in the magazine portion 140, and the groove 135 is provided in the staple driving blade 131 so as to be cut thereinto so that the pushing head portion 235 of the pushing rod 230 is prevented from being brought into contact with the staple driving blade 131. By adopting this configuration, the staple driving blade 131 and hence the housing portion 120 and the handle portion 110 are allowed to return to their original positions easily, and the restoration force applied by the elastic element 127 to restore the handle portion 110 does not have to be increased, and the resistance caused by the elastic element 127 when the handle portion 110 is lowered is not increased. Thus, the fastening device 100 can be provided which is easy to be used.

In this way, in the fastening device 100 of this embodiment, when the staple 251 is driven downwards by the staple driving blade 131, the central portion of the crown portion 253 of the staple 251 is caused to resist the downward pressure applied thereto by the pushing head portion 235, so that the upper ends of the staple legs 255 and the vicinities thereof are pushed downwards strongly by the staple driving blade 131. Therefore, the driving force with which the staple legs 255 are driven perpendicularly into the sheets of paper can be applied to the staple legs 255 in an ensured fashion so that the staple legs 255 are allowed to penetrate through the sheets of paper properly, whereby the staple legs 255 of the staple 251 can be bent as required.

Although the invention is described as being applied to the fastening device 100 which is described as the flat-type fastening device in which the clincher portion 190 including the movable clincher 199 is provided in the base portion 170 so as to bend the staple legs 255 flat, the invention may also be applied to a flat-type fastening device which does not include the movable clincher 199 but has a non-movable clincher or further to a stapler in which staple legs 255 of a staple 251 are bent in a curved fashion.

In addition, the magazine portion 140 is not limited to the type of magazine portion in which the magazine main body portion 151 is pulled out to the front of the magazine case but may include a magazine portion 140 in which a magazine main body portion 151 is pulled out to the rear of the magazine case or a magazine portion 140 in which a magazine main body portion 151 is mounted directly on the base portion 170 and the magazine portion 140 can be opened on an upper side thereof by rotating the housing portion 120.

Additionally, in the embodiment, the magazine main body portion 151 shown in FIG. 4B is such that the distal end of the pushing head portion 235 of the pushing rod 230 which is provided at the center of the magazine bottom plate 153 is in press contact with the magazine front central inner surface 159 of the magazine head portion 158. However, there may also be a situation in which the distal end of the pushing head portion 235 is press contact with the inner surfaces of the magazine front plates 157 which are bent inwards from the front ends of the magazine side plates 155.

As has been described heretofore, the fastening device 100 according to the invention has the pushing rod 230 which can cause the crown portion 253 of the staple 251 to resist the pressure applied thereto when the staple 251 is driven out to the magazine portion 140 so that the staple legs 255 of the staple 251 can be driven perpendicularly into the sheets of paper to thereby fasten the sheets of paper together properly, whereby the fastening device 100 can be made into the stapler which is easy to be used both in offices and at homes as one of stationery materials.

While the embodiments of the invention have been described heretofore, the embodiments are presented to illustrate the examples to carry out the invention and hence are not intended to limit the scope of the invention.

These novel embodiments can be carried out in other various forms, and various omissions, replacements or modifications can be made thereto without departing from the spirit and scope of the invention. These embodiments and their modifications are contained in the spirit and scope of the invention and are also contained in the scope of inventions claimed herein and equivalents thereof.

What is claimed is:

1. A fastening device comprising:
a magazine portion which accommodates a strip of staples and a housing portion which includes a staple driving blade for driving out a staple, between a handle portion and a base portion,
wherein the magazine portion incorporates a staple presser for pressing a staple against a front inner surface of the magazine portion and incorporates a pushing rod in a bottom central position of the magazine portion and the pushing rod being biased so that part of a distal end thereof is brought into contact with a magazine front central inner surface, and
wherein the pushing rod defines a space where a staple of the strip of staples is inserted between the magazine front central inner surface and an upper portion of the distal end thereof and includes an inclined portion which brings the pushing rod into contact with the magazine front central inner surface at a lower portion of the distal end thereof.

2. The fastening device according to claim 1, wherein the pushing rod has a rod-shaped pushing rod main body portion, of which an axis is parallel to a longitudinal axis of the magazine portion, and a pushing head portion which includes a lower projecting portion at a front end of the pushing rod main body portion, the lower projecting portion being as high as a position lying near a lower surface of the magazine portion at a lower end thereof.

3. The fastening device according to claim 2, wherein a groove is cut in the center of a lower end portion of the staple driving blade so as to extend upwards from the lower end portion so that the pushing head portion can be inserted thereinto.
